(19) United States
(12) Patent Application Publication
(10) Pub. No.: US 2025/0240057 A1
(43) Pub. Date: Jul. 24, 2025

(54) METHOD FOR COMPUTING WEIGHTS FOR A BEAMFORMING ALGORITHM FROM AN INTELLIGENT REFLECTING SURFACE

(71) Applicant: Indian Institute of Technology Madras(IIT Madras), Chennai (IN)

(72) Inventors: Uday K. KHANKHOJE, Chennai (IN); Radhakrishna Ganti, Chennai (IN); Sai Sanjay Narayanan, Chennai (IN)

(21) Appl. No.: 19/033,482

(22) Filed: Jan. 22, 2025

(30) Foreign Application Priority Data
Jan. 22, 2024 (IN) 202441004244

(51) Int. Cl. H04B 7/04

(52) U.S. Cl. CPC H04B 7/04013

(57) ABSTRACT

The invention discloses a method of computing weights for a 1-bit phase shifts case of beamforming from an intelligent reflecting surface (IRS) thereof. The method includes the steps of: writing a normalized array factor G of the IRS as a sum of weighted complex exponentials, where weights are binary. Identifying the partitions, the number of which is equal to the number of complex exponentials and equal to the number of unit cells in the IRS. Searching through the partitions and selecting the optimum partition, where assigning weights 104a as 1 and −1, or assigning weights 104b as any two distinct complex numbers per element. Finally step 105a or 105b involves computing the weights. The method discloses two strategies in mitigating grating lobe of an IRS. The method is extremely fast and is guaranteed to return the optimal solution with grating lobe mitigation.

### CROSS-REFERENCES TO RELATED APPLICATION

This application claims priority to Indian Provisional Patent Application No. 202441004244 entitled METHOD FOR COMPUTING WEIGHTS FOR A BEAMFORMING ALGORITHM FROM AN INTELLIGENT REFLECTING SURFACE filed on Jan. 22, 2024.

### FIELD OF THE INVENTION

The invention generally relates to wireless communication and in particular to beamforming for wireless communications.

### DESCRIPTION OF THE RELATED ART

Intelligent Reflecting Surface (IRS) is a technology that is proposed to meet the demands of high data rates and large coverage for 5G and 6G communication networks. IRS is a planar array that consists of reflecting elements called unit cells, that are capable of imparting phase shifts to an incoming wave, and one can control the direction of the reflected beam by optimizing these phase shifts. In a practical implementation, the phase shifts are constrained to belong to a discrete set (usually binary), leading to discrete beamforming problems. There is a need for optimal solutions for beamforming in such communication networks.

### SUMMARY OF THE INVENTION

The invention in its various embodiments discloses methods of computing weights for a 1-bit phase shifts case of beamforming from an intelligent reflecting surface (IRS) thereof. In various embodiments, the method (100) is configured to solve the one bit beamforming problem that guaranteed to return the optimal solution in minimum time due to the linear computational complexity of the algorithms.

In its various embodiments the method (100) includes the steps of: writing (101) a normalized array factor G of the IRS as a sum of weighted complex exponentials, where weights are binary and the phase shifts are constrained to be either 0° or 180°, where the normalized array factor G given by:

$$G ( θ , ϕ ) = \frac{1}{MN} {\sum }_{m = 1}^{M} {\sum }_{n = 1}^{N} {w}_{m , n} {e}^{j {φ}_{m , n} ( θ , ϕ )} , where ,$$

$${φ}_{m , n} ( θ , ϕ ) = \frac{2 π d}{λ} ( - m sin θ cos ϕ - n sin θsinϕ + m sin {θ}_{in} cos {ϕ}_{in} + n sin {θ}_{in} sin {ϕ}_{in} ) ,$$

where d is the inter-cell spacing, and λ is the wavelength of the incident wave.

The next step involves identifying (102) the partitions, the number of which is equal to the number of complex exponentials and equal to the number of unit cells in the IRS.

Searching (103) through the partitions and selecting the optimum partition, wherein selecting the optimum partition comprises assigning weights (104a) as 1 and −1, or assigning weights (104b) as any two distinct complex numbers per element. The final step (105a), or (105b) involves computing the weights.

In its various embodiments, the steps for computing optimum weights where the weights assigned to the complex exponentials in may be 1 and −1 according to step (105a) includes of providing (111) a set of non-zero complex numbers z₁, . . . zₙ followed by setting max to 0. The next step (112) involves initializing i to 1 and if (113) i is greater than 0 and less than or equal to n, δᵢ=arg zᵢ is computed, else the optimal weight is returned (117). After computing the value of δᵢ (113), wⱼ is set to 1 for all j for which arg zⱼ∈[δᵢ, δᵢ+π], else wⱼ is set to −1 (114). Next the value of g is computed (115) where g=|w₁z₁+ . . . w_{N} z_{N}|. Further, (116) if the value of g is greater than max, the value of max is set to g and the optimal weights are updated as [w₁ . . . wₙ], else the optimal weight is returned (117). Finally the value of i is incremented by 1 and the steps (113-116) is repeated until i equals n.

In its various embodiments, the steps for computing optimum weights where assigning weights as any two distinct complex numbers per element (105b) includes providing (121) a set of non-zero complex numbers z₁, . . . zₙ, and constraint sets {a₁, b₁}, . . . {aₙ, bₙ} for each of the weights, where aᵢ≠bᵢ for all i. Next step involves in computing (122) z′₁, . . . z′ₙ, z′ₙ₊₁ as

$$\text{?}$$

$$\text{?} \text{indicates text missing or illegible when filed}$$

Further (123), the steps (111-117) as already illustrated in FIG. 1B are applied to the set z′₁, . . . z′ₙ, z′ₙ₊₁ and the optimal weights are obtained as [\tilde{y}ᵢ . . . \tilde{y}ₙ \tilde{y}ₙ₊₁]. The next step proceeds to check for the condition if (124) \tilde{y}ₙ₊₁ equal to −1. If the condition is false, the optimal weight is computed (126) as

$${\tilde{w}}_{i} = ( \frac{{a}_{i} + {b}_{i}}{2} ) + {\tilde{y}}_{i} ( \frac{{a}_{i} - {b}_{i}}{2} )$$

and the same is returned (127), else the value of i is set to 1. Further if (125) the value of i is greater than 1 and less than or equal to n, the value of −\tilde{y}ᵢ is set to \tilde{y}ᵢ and i is incremented by 1, else the optimal weight is computed (126) as

$${\tilde{w}}_{i} = ( \frac{{a}_{i} + {b}_{i}}{2} ) + {\tilde{y}}_{i} ( \frac{{a}_{i} - {b}_{i}}{2} )$$

and the same is returned (127). The step (125) is repeated until i is less than or equal to n.

This, and other aspects are disclosed herein.

### BRIEF DESCRIPTION OF THE DRAWINGS

The invention has other advantages and features, which will be more readily apparent from the following detailed description of the invention and the appended claims, when taken in conjunction with the accompanying drawings, in which:

FIG. 1A illustrates a method of computing weights for a beamforming algorithm from an intelligent reflecting surface (IRS).

FIG. 1B illustrates the steps for computing optimum weights where the weights assigned to the complex exponentials in may be 1 and −1.

FIG. 1C illustrates the steps for computing optimum weights where the weights assigned to any two distinct complex numbers per element.

FIG. 2 shows a schematic diagram of a 5×5 IRS, with the incident beam wave vector (spherical coordinates (π−θᵢₙ, ϕᵢₙ)) represented in blue and the reflected beam wave vector (spherical coordinates (θ₀, ϕ₀)) represented in red.

FIG. 3 shows complex arg and plane with zᵢs on the unit circle; in (a) the assignment of weights −1 to z₃, z₄ maximizes |G|, while in (b) the assignment of weight −1 to z₄ maximizes |G|. The blue dashed lines indicate the optimal partitioning for weight assignments in each case. (c) An example where n=7 and z₁, . . . z₇ all lie on the unit circle. The red and blue separating lines both give rise to the same partitions, A={z₁, z₃, z₄} and B={z₂, z₅, z₆, z₇}. Further, the set {zⱼ|arg z₂≤arg zⱼ<arg z₂+π} is precisely B. The blue line can be thought of as having angle infinitesimally lesser than arg z₂.

FIG. 4 shows scatter plots of z_{m,n} along with assignment of weights due to (a) thresholding method (b) OPA. The dashed lines indicate the separating line in each case.

FIG. 5 shows the distribution of optimal weights on IRS and the corresponding normalized radiation pattern, for (a) (θᵢₙ, ϕᵢₙ)=(45°, 180°) and (θ₀, ϕ₀)=(−30°, 0°) (b) (θᵢₙ, ϕᵢₙ)=(30°, 225°) and (θ₀, ϕ₀)=(−15°, 45°).

FIG. 6 shows two different alignment scenarios of a vertically deployed 5×5 IRS (x-y plane) with respect to the ground (x′-z′ plane): (a) \hat{x}, \hat{x}′ are parallel, and (b) \hat{x}, \hat{x}′ are at an angle.

FIG. 7 shows the radiation patterns for θᵢₙ=0°, θ₀=−45°, ϕ₀=0°, ϕᵢₙ=180° in a 30×30 IRS: (a) k=0 (SLL=0 dB) (b) k=0.1 (SLL=−2 dB) (c) k=0.3 (SLL=−7.6 dB) (d) k=0.5 (SLL=−10.9 dB).

FIG. 8 shows the radiation patterns along the xz plane corresponding to 30×30 IRS operating at normal incidence, for various θ₀.

FIG. 9 shows the proof of Theorem 2.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The invention in its various embodiments discloses a method 100 of computing weights for a 1-bit phase shifts case of beamforming from an intelligent reflecting surface (IRS) thereof. The method 100 is configured to solve the one bit beamforming problem that guaranteed to return the optimal solution in minimum time due to the linear computational complexity of the algorithms.

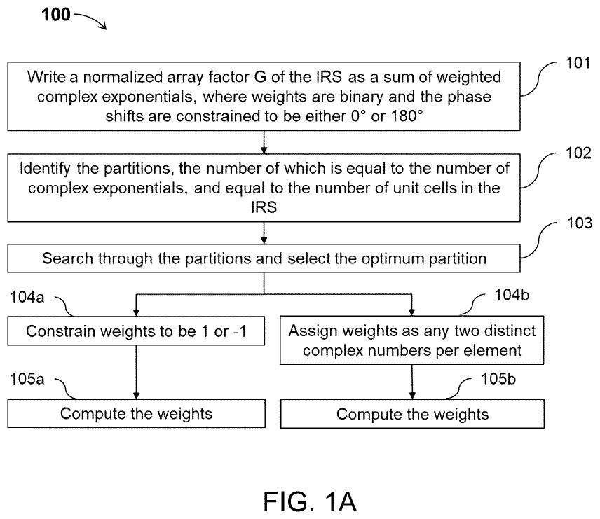

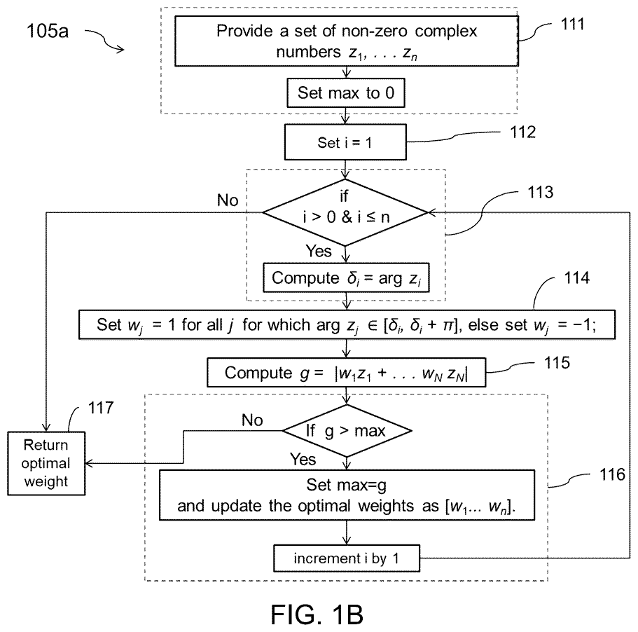

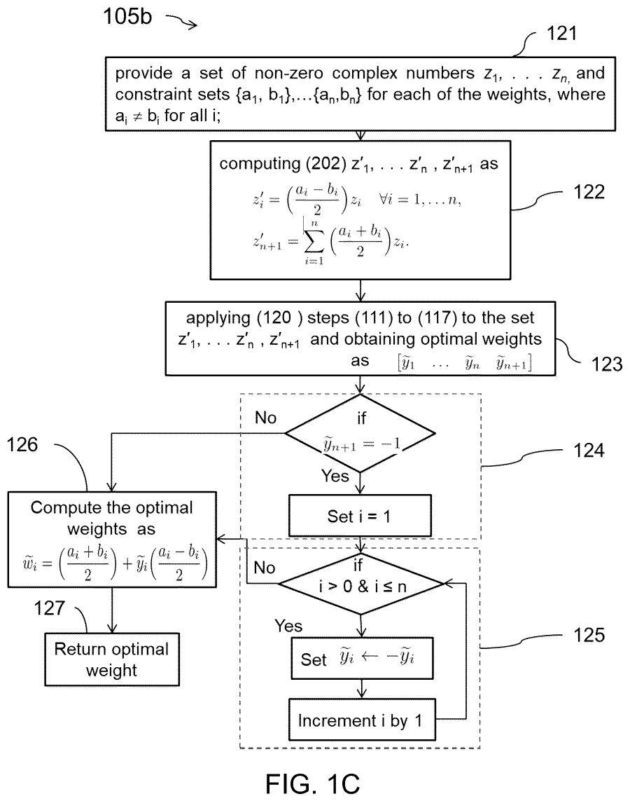

As illustrated in FIG. 1A, the method 100 includes the steps of: writing 101 a normalized array factor G of the IRS as a sum of weighted complex exponentials, where weights are binary and the phase shifts are constrained to be either 0° or 180°, where the normalized array factor G given by:

$$G ( θ , ϕ ) = \frac{1}{MN} {\sum }_{m = 1}^{M} {\sum }_{n = 1}^{N} {w}_{m , n} {e}^{j {ϕ}_{m , n} ( θ , ϕ )} , where ,$$

$${φ}_{m , n} ( θ , ϕ ) = \frac{2 π d}{λ} ( - m sin θ cos ϕ - n sin θ sin ϕ + m sin {θ}_{in} cos {ϕ}_{in} + n sin {θ}_{in} sin {ϕ}_{in} ) ,$$

where d is the inter-cell spacing, and λ is the wavelength of the incident wave.

The next step involves identifying 102 the partitions, the number of which is equal to the number of complex exponentials and equal to the number of unit cells in the IRS. The method then includes searching 103 through the partitions and selecting the optimum partition. Selecting the optimum partition comprises assigning weights 104a as 1 and −1, or assigning weights 104b as any two distinct complex numbers per element. The final step 105a, or 105b involves computing the weights.

As illustrated in FIG. 1B, the steps for computing optimum weights where the weights assigned to the complex exponentials in may be 1 and −1 according to step 105a includes of providing 111 a set of non-zero complex numbers z₁, . . . zₙ followed by setting max to 0. The next step 112 involves initializing i to 1 and if 113 i is greater than 0 and less than or equal to n, δᵢ=arg zᵢ is computed, else the optimal weight is returned 117. After computing the value of δᵢ 113, wⱼ is set to 1 for all j for which arg zⱼ∈[δᵢ, δᵢ+π], else wⱼ is set to −1 114. Next the value of g is computed 115 where g=|w₁z₁+ . . . w_{N} z_{N}|. Further, 116 if the value of g is greater than max, the value of max is set to g and the optimal weights are updated as [w₁ . . . wₙ], else the optimal weight is returned 117. Finally the value of i is incremented by 1 and the steps 113-116 is repeated until i equals n. As illustrated in FIG. 1C, the steps for computing optimum weights where assigning weights as any two distinct complex numbers per element 105b includes providing 121 a set of non-zero complex numbers z₁, . . . zₙ, and constraint sets {a₁, b₁}, . . . {aₙ,bₙ} for each of the weights, where aᵢ≠bᵢ for all i. Next step involves in computing 122 z′₁, . . . z′ₙ, z′ₙ₊₁ as

$$\text{?}$$

$$\text{?} \text{indicates text missing or illegible when filed}$$

Further 123, the steps 111-117 as already illustrated in FIG. 1B are applied to the set z′₁, . . . z′ₙ, z′ₙ₊₁ and the optimal weights are obtained as [\tilde{y}₁ . . . \tilde{y}ₙ \tilde{y}ₙ₊₁]. The next step proceeds to check for the condition if 124 \tilde{y}ₙ₊₁ equal to −1. If the condition is false, the optimal weight is computed 126 a

$${\tilde{w}}_{i} = ( \frac{{a}_{i} + {b}_{i}}{2} ) + {\tilde{y}}_{i} ( \frac{{a}_{i} - {b}_{i}}{2} )$$

and the same is returned 127, else the value of i is set to 1. Further if 125 the value of i is greater than 1 and less than or equal to n, the value of −\tilde{y}ᵢ is set to \tilde{y}ᵢ and i is incremented by 1, else the optimal weight is computed 126 as

$${\tilde{w}}_{i} = ( \frac{{a}_{i} + {b}_{i}}{2} ) + {\tilde{y}}_{i} ( \frac{{a}_{i} - {b}_{i}}{2} )$$

and the same is returned 127. The step 125 is repeated until i equals n.

In various embodiments, the invention discloses strategies to mitigate grating lobes, as their presence is detrimental to the intended operation of an IRS. The invention further includes a vertically oriented IRS (i.e. with its surface normal parallel to the ground), and an incident beam emitted by a transmitter with the wave vector parallel to the ground. There arise two scenarios as: Array x-axis parallel with respect to the ground (ϕ₀=0° and ϕᵢₙ=180°) and array x-axis tilted with respect to the ground (ϕ₀=0° and ϕᵢₙ≠180°).

In various embodiments, the invention discloses two strategies for mitigating the issue of grating lobes while aligning the IRS axis with the ground. In the first strategy, the layout of an IRS is constructed by arraying its elements in a triangular lattice instead of rectangular where it can be shown that ϕ₀=0° and ϕᵢₙ=180° becomes viable for beamforming without encountering the issue of grating lobes. In the second strategy of prephasing, symmetry breaking technique is used to eliminate the grating lobes issue at both normal or nonnormal incidence angle.

The invention has multiple advantages as illustrated further. The method solves the one bit beamforming problem in a computationally efficient way. Thus, due to the linear computational complexity of the problem, the method is extremely fast to deploy in practice and is guaranteed to return the optimal solution. The invention provides grating lobe mitigation where these lobes can lead to security/privacy issues in the context of wireless communications.

### EXAMPLES

### Example 1: Optimum Beamforming and Grating Lobe Mitigation for IRS

### Optimum Beamforming Algorithm & Generalizations

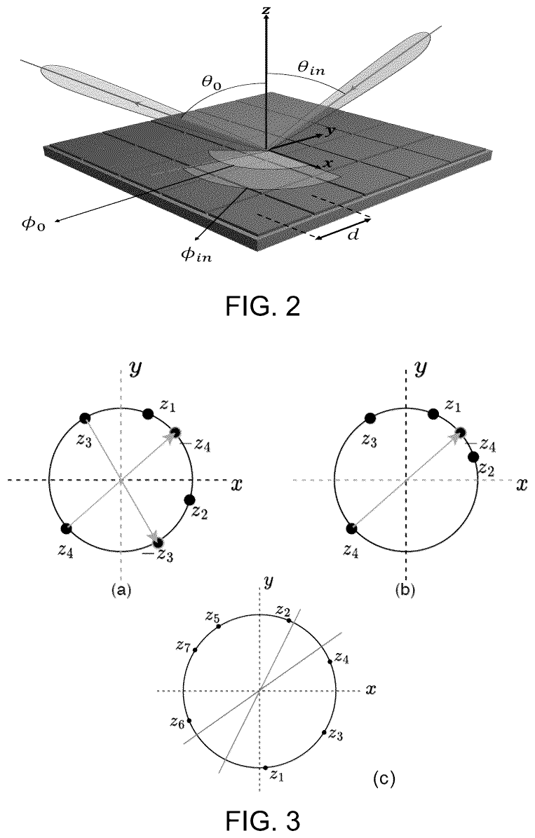

Problem Statement: The IRS is modeled as an M×N rectangular grid of equispaced unit cells in the x-y plane. It is illumined by an incident electromagnetic plane wave in the spherical direction (π−θᵢₙ, ϕᵢₙ) in accordance with the FSA convention, as seen in FIG. 2. Each cell imparts a complex valued reflection coefficient (called the cell weight), w_{m,n}, to the incident beam. In order to capture realistic IRS implementations we assume that the weights take on discrete values, and therefore are modeled as belonging to a discrete alphabet, S_{m,n} (e.g. in many practical implementations, S_{m,n}={−1, 1}).

The normalized array factor G given by:

$$G ( θ , ϕ ) = \frac{1}{MN} {\sum }_{m = 1}^{M} {\sum }_{n = 1}^{N} {w}_{m , n} {e}^{j {ϕ}_{m , n} ( θ , ϕ )} , \qquad ( 1 )$$

$$where$$

$${φ}_{m , n} ( θ , ϕ ) = \frac{2 π d}{λ} ( - m sin θ cos ϕ - n sin θ sin ϕ + m sin {θ}_{in} cos {ϕ}_{in} + n sin {θ}_{in} sin {ϕ}_{in} ) , \qquad ( 2 )$$

where d is the inter-cell spacing, and λ is the wavelength of the incident wave. The array factor is a very useful quantity to compute since it gives the far-zone electric field of the array when multiplied by the radiation pattern of the constitutive array cell (ignoring mutual coupling). We now formally state the problem of beam forming in a certain direction (θ₀, ϕ₀) as:

$${max}_{{w}_{m , n}} {\vert G ( {θ}_{0} , {ϕ}_{0} ) \vert}^{2} s . t . {w}_{m , n} ∈ {𝒮}_{m , n} , ∀ m , n \qquad ( 3 )$$

This is a discrete optimization problem since the weights (w_{m,n}) belong to a finite set. We note that the problem of beamforming can take on many more sophisticated forms as compared to Eq. (3) above; in this work we focus on the simpler, noise-free analysis.

Thresholding Method: Thresholding (also known as quantization) is the most common discrete beamforming algorithm used in the literature. Consider the case where the allowed values for each cell are: S_{m,n}={1,−1}, i.e. a 1-bit IRS, which corresponds to each unit cell having phase shift of 0° or 180° (here, only the phase difference between the states is relevant). In the thresholding method, the main idea is to first obtain the optimal solution to the continuous version of the problem (i.e. we solve Eq. (3) with the constraint as w_{m,n}∈C, |w_{m,n}|=1). Since Eq. (1) is a summation of weighted complex exponentials, this optimal solution is obtained by simply taking w_{m,n}=exp (−jφ_{m,n}(θ₀, ϕ₀)), which yields |G(θ₀, ϕ₀)|=MN. The solution is unique up to multiplication by a unit-magnitude complex number. Once the continuous solution is obtained, we discretize the weights by mapping them to whichever among {1,−1} they are closest to. The complete methodology is presented in Algorithm 1.

Algorithm 1 Thresholding Algorithm
Require: θᵢₙ, ϕᵢₙ: θ₀, φ₀
1: for 1 ≤ m ≤ M, 1 ≤ n ≤ N do
2: Compute w_{m,n} = exp (−jφ_{m,n}(θ₀, ϕ₀)
$3 : if ∠ \text{?} \text{?} ( - \frac{\text{?}}{2} , \frac{\text{?}}{2} ) then$
4: \tilde{w}_{m,n} ← 1
5: else
6: \tilde{w}_{m,n} ← −1
7: end if
8: end for
9: return discrete weights \tilde{w}_{m,n}

$\text{?} \text{indicates text missing or illegible when filed}$

The thresholding method is popular on account of being intuitive and easy to implement. However, due to its heuristic nature it does not have any guarantees of optimality. Further, it is not clear how to generalize the algorithm if the elements of S_{m,n} have unequal amplitude. These observations pave the way for our proposed method, which we present next.

Optimal Partitioning Algorithm: The proposed method is termed the Optimal Partitioning Algorithm (OPA), which is based on the following intuition. The sum of complex exponentials in Eq. (1) can be re-written as G=Σᵢwᵢzᵢ, where wᵢ, zᵢ represent the weights and angle dependent phase terms, respectively. For simplicity, we assume the zᵢs to be unit-magnitude complex numbers, and consider the following two cases. (i) Consider the zᵢs as shown in FIG. 3(a). To maximize |G| as per Eq. (3), the weight wᵢ associated with each zᵢ must be chosen appropriately. Since the wᵢs are restricted to {−1, 1}, it follows that |G| is maximized when all the zᵢs in the left-half of the plane are assigned wᵢ=−1 and those in the right half plane are assigned wᵢ=1 (or vice-versa). In effect, we have found a partitioning line (in this case the y-axis) that separates the assignment of the weights. The resulting weight assignment is equivalent to the thresholding algorithm. (ii) Consider the zᵢs as shown in as shown in FIG. 3(b). As can be seen, the y-axis no longer partitions the weights correctly and instead, a different weight assignment gives the optimal sum. Thus, the thresholding algorithm would have given a suboptimal weight assignment. We note that this optimal assignment can also be conceived of as the result of an optimal partitioning line as indicated by the dashed blue lines in FIG. 3.

The above intuition of an optimal partitioning is formalized via the following two theorems.

Theorem 1: Let z₁, . . . zₙ be arbitrary non-zero complex numbers, and let \tilde{w}₁, . . . \tilde{w}ₙ be an optimal solution to the optimization problem.

$${max}_{{w}_{i}} \vert {w}_{1} {z}_{1} + ⋯ + {w}_{n} {z}_{n} \vert s . t . {w}_{i} ∈ \{ 1 , - 1 \} , ∀ i = 1 , … n \qquad ( 4 )$$

Then, there exists a line l passing through the origin with the following properties:
1) [symbol] does not contain any zᵢ.
2) \tilde{w}ᵢ=1 for all zᵢ lying on one side of the line, and
   \tilde{w}ᵢ=−1 for all zᵢ on the other side.

The above theorem asserts that if an optimal set of weights exists, then there exists a separating line passing through the origin, which partitions the set {z₁, . . . zₙ} into two sets A and B, where \tilde{w}ᵢ=1 for each zᵢ∈A, and \tilde{w}ᵢ=−1 for each zᵢ∈B. However, we know that an optimal solution exists because the feasible set is finite. Therefore, an optimal separating line definitely exists, and our goal should be to find one such line. Once the partition {A, B} is obtained, the assignment of 1 and −1 to each set is arbitrary, as replacing \tilde{w}ᵢ with −\tilde{w}ᵢ for each i=1, . . . n will yield the same value of |Σᵢwᵢzᵢ|.

The natural question that arises is: how many partitions should we check? We must check all partitions that arise due to separating lines passing through the origin. However, multiple separating lines can lead to the same partition, as shown in FIG. 2c. In particular, one has the freedom to rotate a separating line anticlockwise about the origin without changing the partition, until it hits some zᵢ. Therefore, the partition obtained by any separating line is the same as the partition obtained by a separating line whose angle with the x axis is infinitesimally lesser than the argument of some zᵢ. This intuition is formalized in the following theorem.

Theorem 2: A partition {A, B} of {z₁, . . . zₙ} arises due to a separating line passing through the origin not containing any zᵢ, if and only if either A or B is of the form

$$\{ {z}_{j} \vert arg {z}_{i} \leq arg {z}_{j} < arg {z}_{i} + π \}$$

for some i∈{1, . . . n}.

Since there are n complex numbers zᵢ, only n such separating lines (and therefore only n such partitions) need to be investigated. So, an algorithm that seeks the optimal partitioning will have linear time complexity. Finally, we remark that the summations in Eq. (1) and Eq. (4) are identical with zᵢ being equivalent to e^{jφm,n(θ,ϕ)}. Theorems 1 and 2 can now be used to formulate the Optimal Partitioning Algorithm (OPA), which computes the optimal weights for the optimization problem in Eq. (3) with S_{m,n}={−1, 1}. The complete method is displayed in Algorithm 2; since we only need to check n=MN partitions, OPA will find the optimal weights in time O(MN). The optimality of the obtained solution is preserved up to a change of sign, i.e. if {\tilde{w}ᵢ} are optimal, then so are {−\tilde{w}ᵢ}, since both sets give the same value of |G|.

Algorithm 2 Optimal Partitioning Algorithm (OPA)

```
Require: Non-zero complex numbers zₗ,...zₙ
  1: max ← 0
  2: for i = 1 to n do
  3:  Compute δᵢ = arg [symbol]   ᵢ.
  4:  Set wⱼ = 1 for all j such that arg xⱼ ϵ ( [symbol]   ) and
    wⱼ = −1 for others.
  5:  Compute g = | [symbol]   + ... [symbol]  |
  6:  if g > max then
  7:  max ← g
  8:  optimal weights ← [wⱼ ... wₙ]
  9:  end if
10: end for
11: return optimal weights
```

[symbol]

indicates data missing or illegible when filed

Generalized Optimal Partitioning Algorithm: In the OPA previously stated, we had assumed the discrete alphabet as S_{m,n}={−1, 1}. Next, we generalize OPA for the case where the discrete alphabet consists of two arbitrary complex numbers. In many practical situations, such as in metasurface based implementations of IRS structures, the reflection coefficients have less than unity magnitude. Thus, it is important to allow |wᵢ|<1 in the beamforming algorithms to cater to such scenarios. The optimization problem is formulated as:

$${max}_{{w}_{i}} \vert {\sum }_{i = 1}^{n} {w}_{i} {z}_{i} \vert s . t . {w}_{i} ∈ \{ {a}_{i} , {b}_{i} \} , ∀ i = 1 , … n . \qquad ( 5 )$$

To solve this problem, we introduce a new scaled variable, yᵢ, such that

$${w}_{i} = ( \frac{{a}_{i} + {b}_{i}}{2} ) + {y}_{i} ( \frac{{a}_{i} - {b}_{i}}{2} ) ,$$

and rewrite the summation in Eq. (5) as:

$$\text{?} \qquad ( 6 )$$

$$\text{?} \text{indicates text missing or illegible when filed}$$

where

$${z}_{i}^{′} = ( \frac{{a}_{i} + {b}_{i}}{2} ) {z}_{i}$$

for all i=1, . . . n, and

$${z}_{n + 1}^{′} = {\sum }_{i = 1}^{n} ( \frac{{a}_{i} + {b}_{i}}{2} ) .$$

Due to the mapping yᵢ=1→wᵢ=aᵢ and yᵢ=−1→wᵢ=bᵢ, the optimization problem of Eq. (5) is equivalent to the following problem:

$${max}_{\text{?}} \vert \text{?} {y}_{i} {z}_{i}^{′} \vert \qquad ( 7 )$$

$$s . t . {y}_{i} ∈ \{ 1 , - 1 \} , ∀ i = 1 \text{?} n$$

$${y}_{n + 1} = 1 \text{?}$$

$$\text{?} \text{indicates text missing or illegible when filed}$$

The above problem looks almost the same as the problem in Eq. (4), except for the constraint yₙ₊₁=1. Since the solution given by the OPA to Eq. (4) is preserved up to a sign, we can always find an optimal solution to the above problem (i.e. Eq. (7)) by applying the OPA and then using the freedom in the assignment of an overall sign to ensure that yₙ₊₁=1. Thus, we have obtained the Generalized OPA (gOPA), which is summarized in Algorithm 3.

```
Algorithm 3 Generalized OPA (gOPA)
Require: Non-zero complex numbers z₁, ... zₙ, and the con-
  straint sets {a₁, b₁}, ... {aₙ, bₙ} for each of the weights
  (where aᵢ ≠ bᵢ for all i).
1: Compute z₁′ ... zₙ′, zₙ₊₁′ as:
        $\text{?} = ( \frac{{a}_{i} - {b}_{i}}{2} ) {z}_{i} ∀ i = 1 , \text{?}$
        $\text{?} = \text{?} ( \frac{{a}_{i} + {b}_{i}}{2} ) \text{?}$
2: Apply OPA to the set z₁, ... zₙ₊₁′, and get optimal weights
  [\tilde{y}₁ ... \tilde{y}ₙ \tilde{y}ₙ₊₁]
3: if \tilde{y}ₙ₊₁ = −1 then
4: for i = 1 to n do
5: \tilde{y}ᵢ ← −\tilde{y}ᵢ
6: end for
7: end if
8: Compute the optimal weights \tilde{w}₁, ... \tilde{w}ₙ as
        $\text{?} = ( \frac{{a}_{i} + {b}_{i}}{2} ) + \text{?} ( \frac{{a}_{i} - {b}_{i}}{2} )$
9: return optimal weights [\tilde{w}₁ ... \tilde{w}ₙ]
$\text{?} \text{indicates text missing or illegible when filed}$
```

Results for optimal beamforming: In this Section, we provide various simulation results as well as theoretical explanations in support of the efficacy of our proposed method. In all simulations, we take the interelement spacing d=λ/2.

OPA versus Thresholding: We first compare the proposed OPA with the existing thresholding method. The hypothesis is that the thresholding method does not always return the optimal weights, and we provide an example that shows exactly that. Consider a 3×3 array, with incident direction (θᵢₙ, ϕᵢₙ)=(45°, 215°) and the desired direction (θ₀, ϕ₀)=(−30°, 35°). All weights are constrained to the set {1,−1}. From the weights returned by the thresholding method, we obtain |G(θ₀, ϕ₀)|²=−3.86. dB, whereas from the weights obtained by OPA, we obtain |G(θ₀, ϕ₀)|²=−2.95 dB (normalized by the number of elements, MN). FIG. 4 shows the scatter plots the weight assignment for each method. Clearly the OPA results are superior and this example confirms our hypothesis.

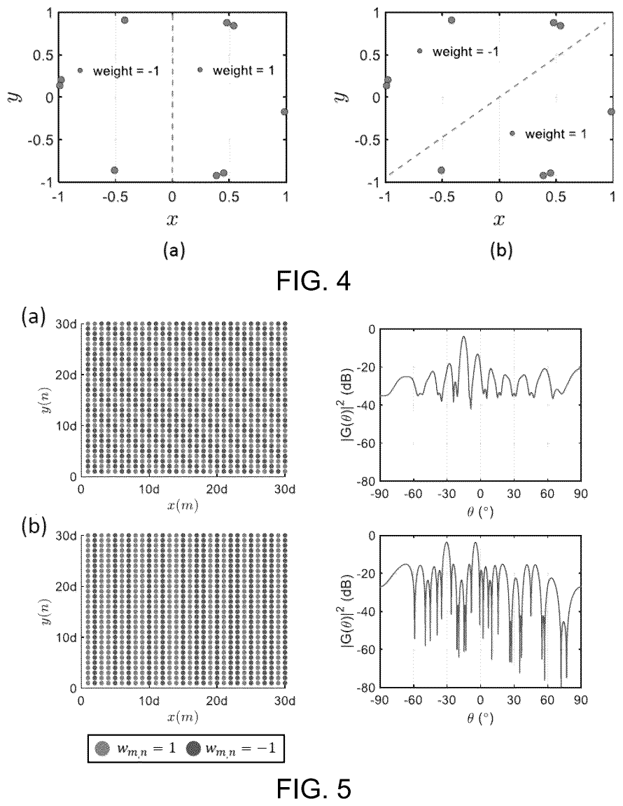

Visualization of weights: Next, we visualize the output of the OPA by plotting the weights distribution across the IRS, and the resulting beam patterns for a couple of sample cases. We fix the array size to be 30×30, and choose θᵢₙ=30°, θ₀=−15° and ϕ₀=45°, ϕᵢₙ=225°. As seen in FIG. 5(a), the distribution consists of diagonal strips of 1 and −1, whose angle with the y axis (vertical axis) is precisely ϕᵢₙ. Intuitively, this makes sense because the strips are precisely the locus of points on the IRS that get the same initial phase due to the incident beam. Next, we consider the case of θᵢₙ=45°, θ₀=−30° and ϕ₀=0°, ϕᵢₙ=180°. As seen in FIG. 5(a), the distribution consists of vertical strips of 1 and −1 as expected. However, in addition to the expected reflected beam at θ₀=−30°, we also observe a second peak of equal strength around θ₀=−5°. Understanding the existence of this second peak is of great importance, and we do so in the following sub-section.

Grating lobe considerations: Having visualized several weight assignments and radiation patterns, we investigate a critical issue in be (8) ming concerning the presence of grating lobes in the radiation pattern. A grating lobe is an undesired lobe with the same intensity as the main lobe (i.e. has sidelobe level (SLL) equal to 0 dB). Such a lobe is seen in FIG. 5(b); these lobes can lead to security/privacy issues in the context of wireless communications and are undesirable. We now derive theoretical conditions under which a grating lobe is guaranteed to exist. By examining the array factor expression in Eq. (1), we can see that given a main lobe at (θ₀, ϕ₀), a grating lobe will appear at (θ*, ϕ*) if the following condition holds for all m, n:

$${φ}_{m , n} ( {θ}^{*} , {ϕ}^{*} ) = - {φ}_{m , n} ( {θ}_{0} , {ϕ}_{0} ) + π am + π bn ,$$

where a and b are even integers, i.e. |G(θ*, ϕ*)|=|G(θ₀, ϕ₀)|. Further, using the phase expression from Eq. (2) and comparing the coefficients of m, n on both sides, Eq. (8) gives:

$$- 2 sin {θ}_{in} cos {ϕ}_{in} - sin {θ}_{0} cos {ϕ}_{0} + \frac{λ a}{2 d} = sin {θ}^{*} cos {ϕ}^{*} ( = A ) \text{?} \qquad ( 9 a )$$

$$- 2 sin {θ}_{in} sin {ϕ}_{in} - sin {θ}_{0} cos {ϕ}_{0} + \frac{λ b}{2 d} = sin {θ}^{*} sin {ϕ}^{*} ( = B ) . \qquad ( 9 b )$$

$$\text{?} \text{indicates text missing or illegible when filed}$$

To check if there is a (θ*, ϕ*) that satisfies this, we must find an a, b such that A²+B²=sin² θ*≤1, with A, B from Eq. (9), holds true. If it does, then we can compute θ*=±arcsin \sqrt{A²+B²} and ϕ*=±arccos \sqrt{A²+B²}. If the resultant (θ*, ϕ*) are different from (θ₀, ϕ₀), then we have a grating lobe.

In order to graphically visualize the algebraic conditions for the existence of a grating lobe (i.e. Eq. (9)), we consider several cases. For ease of visualization, we fix the incidence beam angle and sweep the reflected beam angle, while maintaining the incident and reflected wavevectors to be in the same plane. The heatmaps (not shown here) were generated, showing the region of (θ₀, ϕ₀) for which a grating lobe exists, i.e. for given incident and reflected beam directions, a different (θ*, ϕ*) exists for which the condition in Eq. (9) holds, i.e the regions free of grating lobes. Note that (−θ, ϕ) is equivalent to (θ, ϕ+π); thus the left half of the plots, where θ₀<0, denote the reflected beam going in the forward scattering direction.

We verified the theoretical plots by performing simulations for various arrays, where the optimal weights are obtained using OPA. The simulated heatmaps increasingly agree with the theoretical plot generated using the equation 9, as the array sizes grow. We observed bands around θ₀=45° the simulation, in addition to certain other small regions of non-zero SLL. This happens because the mainlobe does not form exactly at (θ₀, ϕ₀), but rather at a direction close to it, and we refer to angle between the desired direction and the actual direction in which the mainlobe occurs as the beamforming error. We observed that even when θ₀ is close to but not exactly 45° (represented by the blue band), the sidelobe level is not 0 dB, which seems to contradict the theoretical calculation. However, what actually happens is that the mainlobe occurs at 45° rather than the actual θ₀, and indeed 45° corresponds to non-zero SLL according to the calculation. As the array size increases, the beamforming error also decreases, which can be seen by the band becoming narrower.

Grating lobe mitigation: Having identified the existence of grating lobes and confirmed them via simulations, we now seek to propose strategies to mitigate these lobes, as their presence is detrimental to the intended operation of an IRS. As we will demonstrate, the proposed OPA and gOPA algorithms are well suited to implement these mitigation strategies. For sake of definiteness, we only consider 1-bit IRS implementations in this discussion.

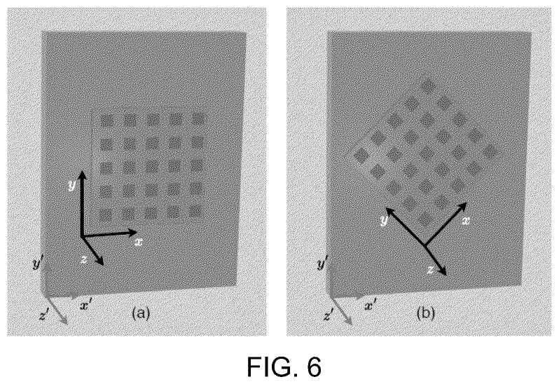

We consider a vertically oriented IRS (i.e. with its surface normal parallel to the ground), and an incident beam emitted by a transmitter with the wavevector parallel to the ground. It is desired to beamform to a mobile user in the same horizontal plane, i.e. ϕᵢₙ=ϕ₀, as depicted in FIG. 6. There arise two scenarios:

Array x-axis parallel with respect to the ground: This amounts to ϕ₀=0° and ϕᵢₙ=180°. As shown by theoretical calculations for ϕ₀=0, a grating lobe always exists, regardless of the value of θᵢₙ. It is easy to see this theoretically, as shown below. Eq. (9) simplifies to:

$$2 sin {θ}_{i n} - sin {θ}_{0} + a = sin {θ}^{*} cos {ϕ}^{*} \qquad ( 10 a )$$

$$b = sin {θ}^{*} sin {ϕ}^{*} . \qquad ( 10 b )$$

Clearly if b=0 and a is chosen to be 2, 0 or −2, depending on whether (2 sin θᵢₙ−sin θ₀) lies in [−3,−1], [−1, 1] or [1, 3] respectively, then a grating lobe exists for ϕ*=0 and θ*=arcsin (2 sin θᵢₙ−sin θ₀+a). The lobe doesn't exist only when θ*=θ₀, which happens for two particular angles (one of them being θ₀=θᵢₙ). Not only does there exist a grating lobe for almost all values of θ₀, the grating lobe also lies along the xz plane, as ϕ*=0.

Array x-axis tilted with respect to the ground: When ϕᵢₙ≠180°, the issue of grating lobes can be circumvented for some user locations. In particular, we see that if θᵢₙ=30°, a user can move in the entire half-range θ₀=[0, 90°] for a tilted IRS with ϕ₀=30° and ϕᵢₙ=210°. Of course, this range is curtailed depending on the size of the array. It is often not convenient to tilt an IRS from an implementation perspective, because most deployments are likely to be on walls or sides of buildings, where a horizontal formfactor is more suitable. Therefore, we outline two strategies that mitigating the issue of grating lobes while aligning the IRS axis with the ground.

Triangular lattice for IRS layout: In all the examples considered so far, the layout of the constitutive elements was assumed to be rectangular (e.g. see FIG. 2). Instead, if we construct an IRS by arraying its elements in a triangular lattice, it can be shown that ϕ₀=0° and ϕᵢₙ=180° becomes viable for beamforming without encountering the issue of grating lobes. The array factor is now modified as:

$$G ( θ , ϕ ) = \frac{1}{MN} {\sum }_{m , n} {w}_{m , n} \text{?} , \qquad ( 11 )$$

$$\text{?} \text{indicates text missing or illegible when filed}$$

where û(θ,ϕ)=[sin θ cos ϕ sin θ sin ϕ cos θ]^{T} and r_{m,n}=md₁+nd₂, with 0≤n≤N and

$$- ⌊ \frac{n}{2} ⌋ \leq m \leq M - ⌈ \frac{n}{2} ⌉ .$$

Here, d₁=d[1 0 0]^{T} and

$${d}_{2} = {d [ \begin{matrix}\frac{1}{2} & \frac{\sqrt{3}}{2} & 0\end{matrix} ]}^{T}$$

are the basis vectors for the lattice.

Analogous to the analysis in the case of the rectangular lattice, we can work out the conditions under which a grating lobe appears. The relations for a grating lobe at (θ*, ϕ*) are:

$$- 2 sin \text{?} - sin \text{?} + \frac{λa}{2 d} = sin \text{?} cos \text{?} \qquad ( 12 a )$$

$$- 2 sin \text{?} - sin \text{?} sin \text{?} + \frac{λ}{2 d} ( \frac{- a + 2 b}{\sqrt{3}} \text{?} = sin \text{?} sin \text{?} \qquad ( 12 b )$$

$$\text{?} \text{indicates text missing or illegible when filed}$$

where a, b are even integers, as in Eq. (9).

Substituting ϕᵢₙ=ϕ₀+π in these relations gives us the theoretical heatmaps and sidelobe levels after the application of OPA for a finite size IRS. A major difference between the SLL heatmaps of the two different lattices is that ϕ₀=0° gives a wide range of grating-lobe free operation for triangular lattices, which is not the case in rectangular arrays. Thus, the triangular lattice enables the alignment of the IRS axis with the ground while mitigating the grating lobe issue.

Prephasing technique for elimination of grating lobes: In the grating lobe considerations considered so far, a nonzero incidence angle was assumed. However, there may be deployment scenarios where keeping θᵢₙ=0 is desired, since this opens up the possibility of steering the reflected beam in either quadrant (i.e. θ₀>0 or θ₀<0). However, this presents a fundamental problem, because when: (a) θᵢₙ=0, and (b) the weights are constrained to {1,−1}, we can show that |G(θ, ϕ)|=|G(−θ, ϕ)| for all (θ, ϕ) and for both types of lattices:

$$G ( - \text{?} , \text{?} ) = \frac{1}{MN} \text{?} = \frac{1}{MN} \text{?} \cdot \text{?} = \text{?} . \qquad ( 13 )$$

$$\text{?} \text{indicates text missing or illegible when filed}$$

The key argument we used is that w_{m,n}=w̅_̅{̅m̅,̅n̅}̅, since each w_{m,n}∈R∀m, n. This symmetry means that there will always be a grating lobe for normal incidence. As earlier work has identified, if the primary assumption of w_{m,n}∈R is attacked (for e.g. by constraining some of the weights to {j,−j}), we arrive at a technique of symmetry breaking. This technique is called prephasing.

There are several techniques to implement prephasing. For instance, adding random phase perturbations to each element of the IRS also helps break the symmetry [15]. Another approach [17] involves shifting subsets of the IRS elements in the normal direction by a small amount. Yet another possibility is to choose a fraction k of tuples from {1, . . . , M}×{1, . . . N} (denoting this set as P), and to then solve the following optimization problem (indeed, [14] does so with k=0.5):

$${max}_{{w}_{m , n}} \vert G ( {θ}_{0} , {ϕ}_{0} ) \vert \qquad ( 14 )$$

$$s . t . {w}_{m , n} ∈ \{ j , - j \} , ∀ ( m , n ) ∈ 𝒫$$

$${w}_{m , n} ∈ \{ 1 , - 1 \} , ∀ ( m , n ) ∈ 𝒫 .$$

In general, there can be more than two prephases [18]. Formally, if the prephase set is {ψ₁, . . . ψ_{P}}, and if {Pᵢ}^{p}ᵢ=1 is a partition of the IRS such that each unit cell in Pᵢ gets the prephase ψᵢ, then the optimization problem becomes

$${max}_{{w}_{m , n}} \vert G ( {θ}_{0} , {ϕ}_{0} ) \vert \qquad ( 15 )$$

$$s . t . {w}_{m , n} ∈ \{ {e}^{j {ψ}_{i}} , {e}^{j ( {ψ}_{i} + π )} \} , ∀ ( m , n ) ∈ {𝒫}_{i} , ∀ i = 1 , … , p .$$

Remarkably, this problem is custom made for solving by the proposed gOPA, as is evident by a comparison of the above equation with the gOPA formulation in Eq. (5). Even with the earlier techniques of random phase perturbations [15], the problem of determining the optimum weights for beamforming can be solved by the gOPA.

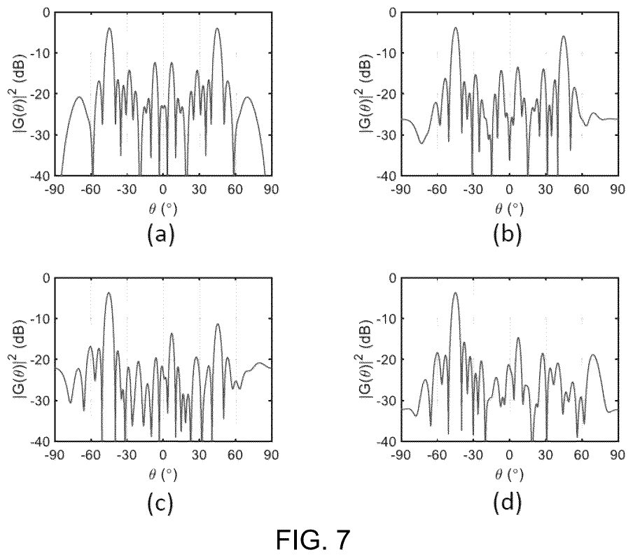

We implement the prephasing method as captured in Eq. (14), and implement the gOPA for various values of the prephasing fraction k. FIG. 7 shows the radiation pattern in the xz plane for several values of k, with the highest SLL suppression of −10.9 dB achieved for k=0.5 in a 30×30 IRS. We also note that while SLL reduces with increasing k, the magnitude of the mainlobe remains the same. Thus, prephasing is a viable means of grating lobe mitigation while not sacrificing the mainlobe magnitude.

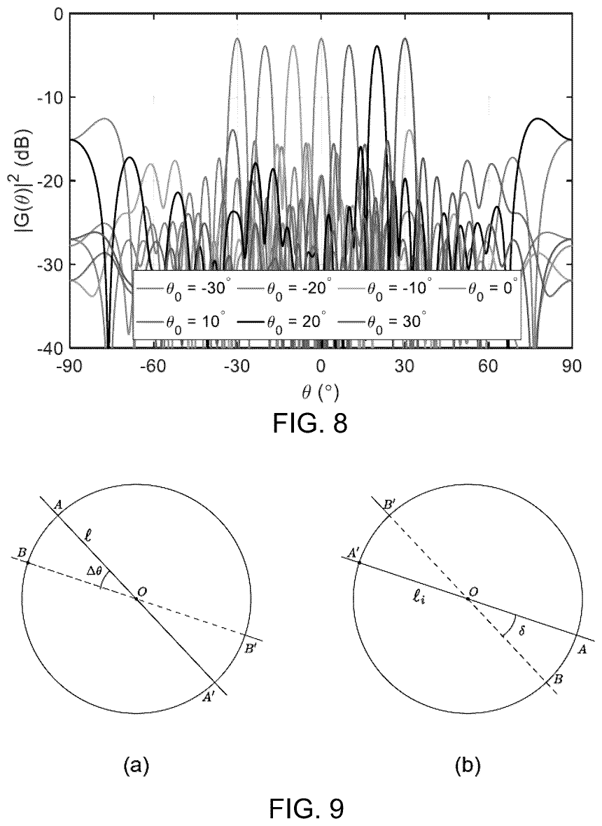

Next, we confirm the feasibility of scanning a single beam across space for (fixed) normal incidence. FIG. 8 shows the radiation patterns along the xz-plane, of a 30×30 IRS in the scanning range [−30°, 30°] spaced by intervals of 10°. The set P is chosen randomly, with k=0.5. The worst-case SLL is observed to be −8.6 dB. We note that the SLL can be further improved by optimizing the set P itself by using evolutionary algorithms, however at a significant computational cost compared to our proposed method.

Finally, we comment on another remarkable outcome of the prephasing approach. While originally designed to eliminate the grating lobes issue at normal incidence, it turns out that it offers the opportunity to deploy the IRS at both normal or nonnormal incidence angle without any issue of grating lobes. We demonstrate this by applying the gOPA on a 30×30 IRS with ϕᵢₙ=ϕ₀=0 and investigate the behaviour w.r.t. incidence angle after implementing prephasing with k=0.5. We confirm grating lobe free operation at normal and non-normal incidence angles (with the exception for small regions at the corners), without having to tilt the IRS axis w.r.t. the ground.

What is claimed is:

1. A method of computing weights for a 1-bit phase shifts case of beamforming from an intelligent reflecting surface (IRS), the method comprising:
writing a normalized array factor G of the IRS as a sum of weighted complex exponentials, where weights are binary and the phase shifts are constrained to be either 0° or 180°, the normalized array factor G given by:
$$G ( θ , ϕ ) = \frac{1}{MN} {\sum }_{m = 1}^{M} {\sum }_{n = 1}^{N} {w}_{m , n} {e}^{j {φ}_{m , n} ( θ , ϕ )} , where ,$$
$${φ}_{m , n} ( θ , ϕ ) = \frac{2 π d}{λ} ( - m sin θ cos ϕ - n sin θ sin ϕ + m sin {θ}_{in} cos {ϕ}_{in} + n sin {θ}_{in} sin {ϕ}_{in} ) ,$$
where d is the inter-cell spacing, and λ is the wavelength of the incident wave;
identifying the partitions, the number of which is equal to the number of complex exponentials, and equal to the number of unit cells in the IRS;
searching through the partitions and selecting the optimum partition, wherein selecting the optimum partition comprises assigning weights as 1 and −1, or assigning weights as any two distinct complex numbers per element; and
computing the weights.

2. The method as claimed in claim 1, wherein the computing comprises:
providing a set of non-zero complex numbers z₁, . . . zₙ, wherein a maximum value thereof is set to 0;
setting i=1;
computing for i=1 to n, δᵢ=arg zᵢ;
setting wⱼ=1 for all j for which arg zⱼ∈[δᵢ, δᵢ+π], else set wⱼ=−1;
computing g=|w₁z₁+ . . . w_{N} z_{N}| setting max to g if g>max, and updating the optimal weights accordingly; and
returning the optimal weights.

3. The method as claimed in claim 2, wherein the computing comprises:
providing a set of non-zero complex numbers z₁, . . . zₙ, and constraint sets {a₁, b₁}, . . . {aₙ, bₙ} for each of the weights, where aᵢ≠bᵢ for all i;
computing z′₁, . . . z′ₙ, z′ₙ₊₁ as
$${z}_{i}^{′} \text{?} ( \frac{{a}_{i} - {b}_{i}}{2} ) {z}_{i} ∀ i \text{?} 1 , … n ,$$
$${z}_{n + 1}^{′} = \text{?} ( \frac{{a}_{i} - {b}_{i}}{2} ) {z}_{i} \text{?} ;$$
$$\text{?} \text{indicates text missing or illegible when filed}$$
applying steps (111) to (117) to the set z′₁, . . . z′ₙ, z′ₙ₊₁ and obtaining weights as [\tilde{y}₁ . . . \tilde{y}ₙ \tilde{y}ₙ₊₁];
setting i=1 if \tilde{y}ₙ₊₁=−1 (124);
setting \tilde{y}ᵢ←−\tilde{y}ᵢ for i=1 to n;
computing optimal weights [\tilde{w}₁ . . . \tilde{w}ₙ] as
$$\text{?} = ( \frac{\text{?}}{2} ) + \text{?} ( \frac{\text{?}}{2} ) ;$$
$$\text{?} \text{indicates text missing or illegible when filed}$$
and
returning the optimal weights.
